(19) United States
(12) Patent Application Publication
(10) Pub. No.: US 2011/0161304 A1
(43) Pub. Date: Jun. 30, 2011

(54) DEPLOYMENT AND COMPLIANCE MANAGER

(75) Inventors: Jeffrey Thomas Carr, Highland Village, TX (US); Mohsin Karim, Irving, TX (US); Awais Iqbal, Irving, TX (US)

(73) Assignee: Verizon North Inc. (SJ), Fort Wayne, IN (US)

(21) Appl. No.: 12/650,264

(22) Filed: Dec. 30, 2009

(51) Int. Cl. G06F 17/30; G06Q 10/00

(52) U.S. Cl. 707/694; 707/758; 707/769; 707/E17.005; 707/E17.014

(57) ABSTRACT

A system includes a first database configured to store agreement information corresponding to terms of an agreement between a service provider and a third party. A second database is configured to store records related to the agreement. A computing device is configured to compare the records to the agreement information to determine whether the service provider is in compliance with the terms of the agreement.

### BACKGROUND

Various businesses use one or more databases to store records with categorized information. However, updating these records can be time-consuming and error-laden. For example, updating the records may require a user to load the records in a tabular form, edit various values of the record, and overwrite a file containing the unedited records with a file containing the edited records. This system requires the user to have continuous access to a server storing the records, which limits the user's ability to update records from a remote location. In addition, existing systems do not allow the user to customize the way the records are presented. Therefore, the user is required to download more records than needed, and must sift through numerous records to access the record that needs updating. Accordingly, a system is needed that allows the user to customize the download and view of the records, as well as update records from remote locations.

### BRIEF DESCRIPTION OF THE DRAWINGS

FIG. 1 illustrates an exemplary system having a data portal that allows a user to interface with a record server;

FIG. 2 illustrates an exemplary process implemented by the system of FIG. 1;

FIG. 3 illustrates an exemplary interface presented by the data portal;

FIG. 4 illustrates another exemplary interface presented by the data portal; and

FIG. 5 illustrates another exemplary process implemented by the system of FIG. 1.

### DETAILED DESCRIPTION

An exemplary system includes a client machine having a data portal that is configured to receive a query from a user, download one or more records from a record server to the client machine based on the query, receive edits for one or more of the downloaded records from the user, and upload one or more of the edited records back to the record server. In one exemplary approach the system lets the user download only those records that are defined in the query, and gives the user the opportunity to edit records from a remote location.

The data portal described herein may allow a service provider's regional engineers to update engineering records associated with local franchise authority (LFA) agreements. LFA agreements may define the service provider's obligation to provide service to customers within a specific area, such as a geographical area. For example, the LFA agreement may define a minimum percentage of residential and commercial buildings to which the service provider must provide service in a specific county. The LFA agreement may designate the specific area based on addresses or a type of address (e.g., residential, commercial, industrial, etc.), and exclude specific addresses or groups of addresses within the specific area. The data portal described herein may be used to determine whether the service provider has fulfilled its obligations under the LFA agreement, and if not, the data portal may be used to determine the additional resources that must be provided to fulfill the LFA agreement.

For instance, the service provider may have agreed to provide fiber-to-the-premises service to all residential households in a municipality, the terms of which are defined by one or more LFA agreements. Using the information provided by the data portal described herein, regional engineers can determine whether the fiber-to-the-premises service was properly deployed and whether the service complies with the LFA agreements.

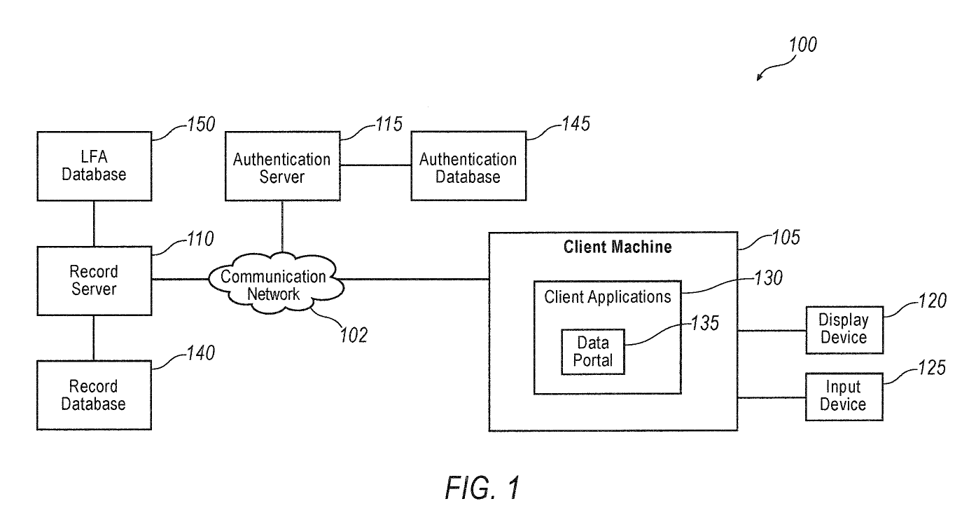

The system described herein may take many different forms and include multiple and/or alternate components and facilities. While an illustrative system 100 is shown in FIG. 1, the exemplary components illustrated in FIG. 1 are not intended to be limiting. Indeed, additional or alternative components and/or implementations may be used.

As illustrated in FIG. 1, the system 100 includes a client machine 105 in at least selective communication with a record server 110 via a communication network 102. The system 100 may further include an authentication server 115 in communication with the records server via the communication network 102. The communication network 102 may include any number of secured or unsecured interconnected networks. For example, the communication network 102 may include the Internet.

The client machine 105, record server 110, and authentication server 115 may include one or more computing systems, one or more computing devices, or both. In general, computing systems and/or devices may employ any of a number of well known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

The client machine 105 may further include a display device 120 and an input device 125. The display device 120 may be any output device configured to present visual or auditory information to the user. For example, the display device 120 may include a computer monitor. The input device 125 may be configured to provide data and control signals to the client machine 105, either automatically or in response to inputs from the user. For example, the input device 125 may include a keyboard, mouse, or both. The display device 120, the input device 125, or both, may be built into the client machine 105 or may be peripheral devices connected to the client machine 105 through, for example, a wireless protocol such as Bluetooth™ or through a wired connection such as a universal serial bus (USB), or the like.

The client machine 105, record server 110, and authentication server 115 may include one or more client applications 130, such as a data portal 135. The client applications 130 may include any computer executable instructions that may be executed by the client machine 105, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The data portal 135 may include software, hardware, or a combination of both that allows a user to interface with the record server 110. For example, as discussed in greater detail below, the data portal 135 may be configured to access the record server 110 in response to an input or query from the user, download records from the record server 110, and allow the user to manipulate the display of the records and edit the records. In addition, the data portal 135 may be configured to upload the edited or downloaded records back to the record server 110.

The data portal 135 may operate on the client machine 105 as a stand-alone program or be embedded in another application, such as a web browser. Moreover, the data portal 135 may be configured to upload records to the record server 110 in real-time, in near real-time or when prompted by the user. This way, the user may edit records remotely or during times the client machine is not connected to the record server via the communications network. In one exemplary approach, the client machine 105 may be disconnected from the communication network 102 and the data portal 135 may be configured to upload the records to the record server 110 as soon as the client machine 105 is reconnected to the communication network 102. Alternatively, the data portal 135 may be configured to upload the records to the record server 110 at predetermined intervals or in response to an input from the user.

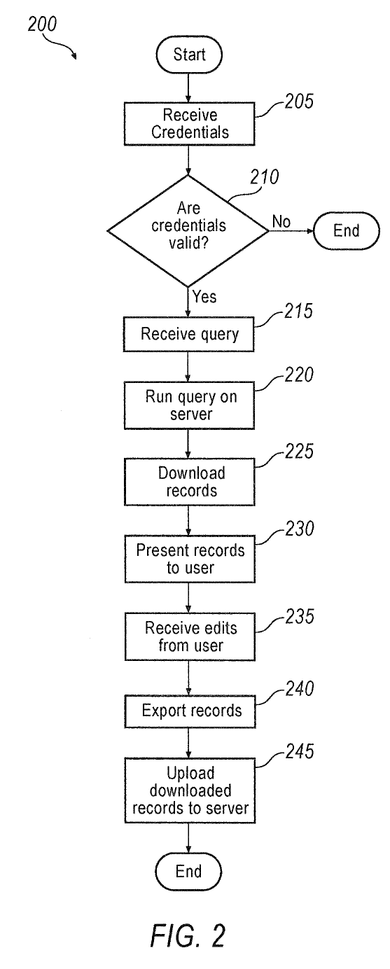

The data portal 135 may further be configured to receive a query from the user. The query may be input by the user to define which records to download from the record server 110 to the client machine 105. The query may include any set of criteria defined by the user. For example, as discussed in greater detail below with reference to FIG. 2, the records in the record server 110 may store information in various categories, such as a customer's name, address, region, subscribed services, or any other information. The query may be used to search for one or more values in each of the categories using, for example, Boolean or logical operators (e.g., AND, OR, NOT, etc.), mathematical operators (“=” representing equal to, “!=” representing not equal to, “<” representing less than, “>” representing greater than, “<=” representing less than or equal to, “>=” representing greater than or equal to), wildcard operators (e.g., “%”), and the like. Any combination of these or other operators may be used.

The data portal 135 may be configured to present records to the user in various formats. For example, the records may be presented to the user in a spreadsheet format having cells containing values. The spreadsheet may include rows and columns, and each row may correspond to a record and each column may correspond to a predefined category. The data portal 135 may be configured such that the user may edit some or all of the cells to update information or values in one or more of the cells. The data portal 135 may further be configured to keep track of which records the user edited and to only upload the edited records to the record server 110. Alternatively, the data portal 135 may be configured to upload all of the downloaded records back to the record server 110. In addition, the data portal 135 may be configured to export the records to a file, such as a comma-separated value (CSV) file or a portable document format (PDF) file.

The data portal 135 may be further configured to allow the user to adjust the way the records are presented to the user. For example, the data portal 135 may allow the user to change the order of the records such as by allowing the user to view the records in numerical or alphabetical order based on the values or information in one of the categories. In one illustrative approach, the data portal 135 may be configured to allow the user to filter the records by, for example, hiding records that do not meet various criteria defined by the user or by placing records that meet the filter criteria near the top of the spreadsheet. Using the filter, the data portal 135 may display the records in a way that is convenient for the user. The user may define the filter using Boolean or logical operators, mathematical operators, wildcard operators, and the like. Unlike the query previously described, the filter may only apply to the downloaded records whereas the query applies to all of the records stored on the record server 110.

The data portal 135 may further be configured to prompt the user for credentials to verify that the user is authorized to use the data portal 135 to access the records prior to allowing the user to access the records. The credentials may include a user identification and password. Once received, the data portal 135 may be configured to transmit the user's credentials to the record server 110 using the communication network 102 to authenticate the user. The data portal 135 may prompt the user to input credentials every time the user accesses the data portal 135. Alternatively, the data portal 135 may authenticate the user other ways. For example, the data portal 135 may authenticate the user based on the user's Internet protocol (IP) address. In one exemplary implementation, the data portal 135 may initially prompt the user for credentials. Once received, the data portal 135 may associate the user's credentials with the user's IP address. So long as the user accesses the data portal 135 from the same IP address, the data portal 135 may automatically retrieve the user's credentials and transmit the credentials to the record server 110 as described in greater detail below. However, the data portal 135 may prompt the user to input his or her credentials if the IP address is unknown by the data portal 135 to be associated to a particular user.

The record server 110 may include a combination of hardware and software configured to communicate with the client machine 105 over the communication network 102 and interface with the data portal 135. The record server 110 may include one or more record databases 140 that store the records that may be accessed by the user via the data portal 135. The record server 110 may be configured to execute queries of the records. For example, the record server 110 may be configured to compare criteria defined by the query to the values in the records. Further, the record server 110 may be configured to compile the records that meet the criteria defined by the query into a spreadsheet or another type of download file, and transmit the download file to the data portable. In addition, the record server 110 may be configured to track downloads of the records to the client machine 105. Therefore, if the system 100 includes multiple client machines 105, the record server 110 may identify which client machine 105 last downloaded the record. In addition, the record server 110 may keep a log of edits made to each of the records, and identify the client machine 105 used to make the edits. For example, the log may include the name of the client machine 105 or one or more of the credentials of the user of the data portal 135, such as the user identification.

In one exemplary approach, the record server 110 may be configured to store information relating to local franchise authority (LFA) agreements in an LFA database 150. Alternatively, a different server other than the record server 110 may store LFA information in the LFA database 150. Each LFA agreement may define obligations of a service provider relative to a third party, such as a municipality. The obligations may be defined as terms of the LFA agreement. The agreement between the service provider and the third party may be defined by one or more LFA agreements. The information stored in the LFA database 150 may include addresses of residences and businesses that are covered by the LFA agreement, addresses of residences and businesses that are excluded by the LFA agreement, and the like. The data portal 135 may further be configured to compare the records from the record database 140 to the information stored in the LFA database 150 and determine the extent to which the service provider complies with one or more of the LFA agreements.

In addition to storing records, the record server 110 may be configured to store credentials, such as user identifications and passwords, and interface with the data portal 135 of the client machine 105 to authenticate the user. For example, the record server 110 may be configured to compare the credentials input by the user at the data portal 135 to the stored credentials and allow the user access to the record database 140 if the credentials match.

The authentication server 115 may alternatively be used to store credentials and interface with the data portal 135 of the client machine 105 directly or via the record server 110. For example, the authentication server 115 may include an authentication database 145 that stores user identifications and passwords for multiple users and is configured to compare the credentials input by the user at the data portal 135 to stored credentials. The authentication server 115 is configured to grant the user access to the record database 140 if the credentials match.

The user's level of access to the record server 110 may be based upon a user profile stored on the authentication server 115, the record server 110, or the client machine 105. The user profile may identify, for example, whether the user is able to view the records stored in the record database 140, download the records to the client machine 105, edit the records, upload the records to the record server 110, etc.

Databases, data repositories or other data stores, such as the record database 140 and the authentication database 145 described herein, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via the communication network 102 in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

In some exemplary illustrations, elements of the system 100 may be implemented as computer-readable instructions (e.g., software) on one or more computing devices (e.g., servers, personal computers, etc.), stored on computer readable media associated therewith (e.g., disks, memories, etc.).

FIG. 2 illustrates an exemplary process 200 that may be performed by one or more of the elements of the system 100 previously described.

Block 205 includes receiving credentials. For example, the user may be prompted to input credentials into the data portal 135 of the client machine 105 prior to being granted access to records on the server 110 and record database 140. The user may have access to the data portal 135 and to records previously stored in client system hardware memory on client machine 105. The user may input his or her credentials using the input device 125. The data portal 135 may require the user to input his or her credentials every time the user accesses the data portal 135, or may store the credentials on the client machine 105 and transmit the credentials automatically without any further interaction from the user. The data portal 135 may transmit the credentials to the record server 110 or to the authentication server 115 directly or via the record server 110 to authenticate the identity of the user.

Decision point 210 includes determining whether the user's credentials are valid. In one exemplary approach, the authentication server 115 compares the user's credentials received from the client machine 105 to stored credentials (e.g., user identifications and passwords). If the user's credentials match the credentials stored in the authentication server 115, the authentication server 115 may transmit a message to the record server 110 indicating that the user of the client machine 105 is authorized to access the records stored in the record database 140. Also, the authentication server 115 may transmit the user profile to the record server 110, which defines the level of access granted to the user. Alternatively, the record server 110 may determine whether the user's credentials are valid. For example, the authentication server 115 may transmit the password associated with the user name input by the user to the record server 110. The record server 110 may compare the password received from the authentication server 115 with the password received from the user and authenticate the user based on whether the passwords received match. If the passwords match, the authentication server 115 may transmit the user profile to the record server 110. Moreover, the record server 110 may be configured to determine whether the user's credentials are valid without any interaction with the authentication server 115. For example, the record server 110 may include an authentication database 145 storing user identifications and passwords, as well as user profiles defining the level of access granted to each user. If the user's credentials do not match those stored in the authentication database 145 or elsewhere, the method ends, limiting the user to data retrieval from client machine 105. The user may edit and store changes on client machine 105, but cannot transfer data changes to record server 110 until the user is successfully authenticated. If the user's credentials match those stored in the authentication database 145, the user is authenticated and the process 200 continues to block 215.

Block 215 includes receiving a query. For example, the user may input the query into the client machine 105 using the input device 125. As previously discussed, the query may include any set of criteria defined by the user to indicate which records the user would like to download to the client machine 105. For example, the user may input any number of operators and search criteria into the data portal 135 using the input device 125 of the client machine 105. The user may instruct the data portal 135 to transmit the query to the record server 110 via the communications network by, for example, clicking a button on the input device 125 or using the input device 125 to click a virtual button in the data portal 135.

Block 220 includes running the query on the record server 110. The record server 110 may execute the query by accessing the records in the record database 140 and comparing one or more values in each of the records to the search criteria defined by the query. The record server 110 may compile records that match the criteria defined by the query into a spreadsheet or another type of download file to transmit to the data portal 135. If no records meet the search results, the user may be prompted to input additional search criteria into the query. For example, the record server 110 may transmit a message to the data portal 135 indicating that no records meet the search criteria and that the user should revise the query. The message maybe presented to the user of the client machine 105 via the display device 120. The process 200 may then return to block 220.

The download file of the records that meet the criteria defined by the query may be copied or downloaded to the client machine 105 as illustrated in block 225. In one illustrative approach, the records meeting the query criteria may be copied from the record database 140 and transmitted to and stored locally on the client machine 105 while the original version of the record remains stored in the record database 140. Alternatively, the records meeting the search criteria may be transmitted to the client machine 105 and deleted from the record database 140 so that only one copy of each record exists at any time.

Block 230 includes displaying the records to the user using the display device 120. For example, the data portal 135 may present the download file to the user in a way that makes the records easy to view on the display device 120. In one exemplary approach, the records may be displayed in a format such as in a spreadsheet having rows and columns. Each row may include a different record, and each column may correspond to the categories of the record. Each cell in the spreadsheet may include a value for one of the records. The data portal 135 may be configured to allow the user to alter the display of the records, including changing the order of the records. For example, the user may click a header of one of the columns. In response, the data portal 135 may be configured to sort the records based on value in the column in either ascending or descending order. Moreover, the data portal 135 may be configured to allow the user to filter the records. Filtering may include sorting the records in a particular order, hiding various records, and the like so that the user may define the way in which the records are presented on the display device 120. This way, the user may view the most important records.

Block 235 includes receiving edits from the user. For example, the user may use the input device 125 to edit information corresponding to one or more of the records via the data portal 135. As previously discussed, the records may be presented to the user in a spreadsheet format. The user may click on a cell corresponding to one of the records using a mouse, and input information into one or more cells using a keyboard. The data portal 135 may be configured such that the user is able to edit the records indefinitely. Furthermore, the data portal 135 may also be configured to restrict edit capabilities of certain fields within records based on user rights defined and stored in authentication server 115.

At block 240, the user may instruct the data portal 135 to export one or more of the downloaded records. The records may be exported to a file such as a comma-separated value (CSV) file, a portable document format (PDF), or the like. The exported file may be stored locally on the client machine 105, emailed, printed, etc.

Block 245 includes uploading the records to the record server 110. For example, the user may, using the input device 125, click a virtual button in the data portal 135 indicating that the user is finished editing records and that the edited records are ready to be uploaded to the record server 110. In one exemplary implementation, the data portal 135 may identify which records were edited and transmit a file containing only the edited records to the record server 110. Alternatively, the data portal 135 may transmit a file containing all of the records, edited or unedited, to the record server 110. Once received, the record server 110 may extract the records from the file, and copy the records to the record database 140 to overwrite corresponding records in the record database 140. In addition, the record server 110 may add new records if there is not a corresponding record in the record database 140. Further, if the client machine 105 is not connected to the record server 110 via the communication network 102, the data portal 135 may be configured to wait until communication with the record server 110 is established before attempting to upload the edited records. This way, the user may be able to update records when not connected to the communication network 102. Furthermore, at any time, whether connected or not connected to record server 110, the user may save and/or store the record changes to client machine 105 using features available on data portal 135.

The data portal 135 described herein may allow various authorized users to easily access and edit records, including tabular data, that exist in the record database 140. The data portal 135 may streamline the availability of important records and minimize unnecessary hand-offs of spreadsheets and emails.

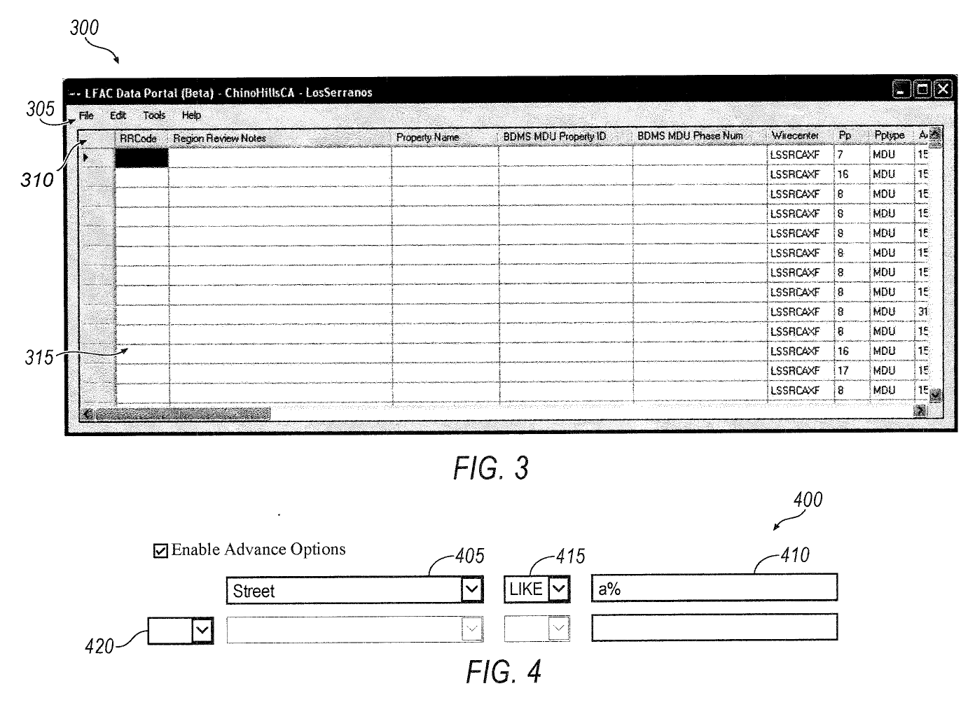

FIG. 3 illustrates an exemplary interface 300 presented by the data portal 135 that may be used to view and edit records. The interface 300 may include a menu bar 305, column headers 310 for labeling and organizing record information, and a plurality of cells 315 for viewing record information. Data in one or more of the cells 315 may be edited by the user, or the user may be able to enter record information into one or more of the cells 315. In one exemplary approach, one or more of the cells 315 may be protected so that the user is unable to edit or add data. Accordingly, one or more of the cells 315 may be “read-only” to the user.

The menu bar 305 may include any number of menu options (e.g., “File,” “Edit,” “Tools,” and “Help”). Each of the menu options in the menu bar 305 may be selected by the user using the input device 125. For example, if the input device 125 includes a mouse, the user may use the mouse to direct a pointer to the desired menu option in the menu bar 305. In one exemplary approach, selecting one of the menus from the menu bar 305 presents the user with a “drop-down” list. In other words, additional menu items are presented to the user after the user selects one of the menu options. Additionally, each menu option may be associated with a “shortcut key.” Therefore, if the input device 125 includes a keyboard, the user may simply press the appropriate shortcut key to select the menu option.

As illustrated, the menu bar 305 of FIG. 3 includes a “File” menu, an “Edit” menu, a “Tools” menu, and a “Help” menu. The “File” menu may allow the user to log into the data portal 135 if, for example, the user has not already done so. In one exemplary approach, logging into the data portal 135 may not be necessary to edit previously downloaded records, but may be necessary to download additional records. The “File” menu may also provide the user with an option to open a project file. The project file may include one or more records previously downloaded from the record database 140. The “File” menu may further allow the user to download records from the record server 140 as described above, and save changes to the records if, for example, records have been edited. For example, the data portal 135 may present the user with a pop-up window indicating that records have been edited and prompting the user to save the edits prior to exiting the data portal 135. In response to the user saving the records, the data portal 135 may only save the records with changes or edits. Furthermore, the data portal 135 may require the user to save the records before the records may be updated to the record server 140. The “File” menu may further provide the option of uploading the records to the server 110, closing the current project file displayed, or exit the data portal 135 application.

The “Edit” menu may allow the user to copy data from records to a “clipboard” of the client machine 105, or paste information from one cell 315 to another cell 315 or from the clipboard to one or more of the cells 315. Furthermore, the “Edit” menu may allow the user to delete data from one or more cells 315, filter data based on the column headers 310, for example, remove the filter applied, or sort data by the values in one or more of the cells 315.

The “Tools” menu may allow the user to export the records to, for example, a comma-separated value (CSV) file or view reports generated by the data portal 135.

The “Help” menu may allow the user to view user activity such as the time and date of the previous download or upload, view a user guide, and review the application and version number of the data portal 135.

The data portal 135 may allow the user to sort the records based on the column headers 310. For example, using the input device 125, the user may click or double-click one of the column headers 310 to sort all of the records by the data in that column in either ascending or descending order. The user may click or double-click the same column header 310 again to sort the records by the data in that column in reverse order.

To initiate row selection, the user may click on any field. The data portal 135 may include a selection arrow indicating the current row in which the user may input or edit data.

The data portal 135 may allow the user to remove an entire record, one or more rows at a time, or alternatively, filter the records to only show specific rows. The records may be filtered by the user specifying search criteria for one or more categories that may be defined by, for example, the column headers 310. The data portal 135 may further allow the user to rearrange columns by “dragging and dropping” the column to the desired location relative to the other columns. Furthermore, the user may be able to customize the width of each of the columns by, for example, dragging a line separating column headers 310 to a desired width. Alternatively, the user may be able to customize the width of the column relative to the data within one or more of the cells 315 in that column. For example, the column width may be customized to fit the width of the cell 315 in that column with the longest string of data.

FIG. 4 illustrates another exemplary interface 400 presented by the data portal 135 that may be used to filter records. The exemplary interface 400 may include one or more search strings including a category field 405, a search field 410, and an operator field 415, and an add search field 420.

The category field 405 may allow the user to identify a specific category in which to perform a search. For example, the category field 405 may correspond to the column headers 310 of FIG. 3. In one exemplary approach, the category field 405 may include a drop-down list that presents the user with the column headers 310. The drop-down list may be selected by the user using the input device 125.

The search field 410 may allow the user to input search criteria using, for example, text, numbers, or wildcard characters. In one exemplary approach, one wildcard character may allow the user to match any string of zero or more characters, while another wildcard character may allow the user to match any single character. For example, to search for all addresses that contain the word “loop,” the user may select “Address” from the category field 405 and type “%loop%” in the search field, where “%” is a wildcard character representing any string of characters. As illustrated in FIG. 4, to search for all streets beginning with the letter “a,” the user may select “Street” from the category field 405 and type “a%” into the search field 410. Again, the “%” wildcard may represent any string of characters. To search for all zip codes that begin with “75,” the user may select “Zip” from the category field 405 and type “75” followed by three underscore (“_”) characters (e.g., “75___”), where each underscore represents any single character.

The operator field 415 may include any number of operators that link the category selected in the category field 405 to the search criteria input into the search field 410. The operator field 415 may include a drop-down list of operators including Boolean or logical operators (e.g., AND, OR, NOT, etc.), mathematical operators (“=” representing equal to, “!=” representing not equal to, “<” representing less than, “>” representing greater than, “<=” representing less than or equal to, “>=” representing greater than or equal to), a “LIKE” operator to use with wildcard characters, and the like.

The add search field 420 include any number of operators that allow the user to add additional search criteria. For example, the add search field 420 may include a drop-down list of Boolean or logical operators (e.g., AND, OR, NOT, etc.). This way, the user may identify additional search criteria or alternative search criteria.

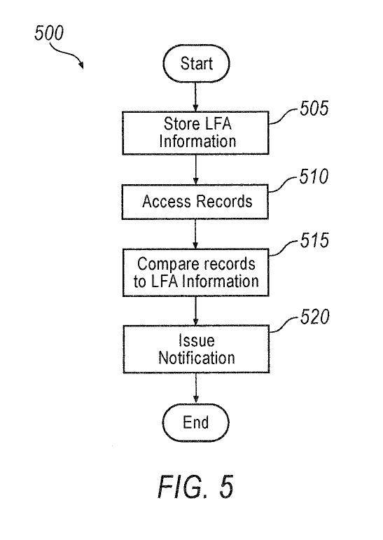

FIG. 5 illustrates an exemplary process 500 that may be implemented by one or more of the elements of the system 100 of FIG. 1.

Block 505 may include storing LFA information. For example, the LFA information may be placed or stored in the LFA database 150, the record database 140, in the record server 110, or in another server not illustrated in FIG. 1. The LFA information may include information regarding the obligations of a service provider relative to a third party, such as a municipality. For example, the LFA information stored in the LFA database 150 may include addresses of residences and businesses that are covered by the LFA agreement, addresses of residences and businesses that are excluded by the LFA agreement, and the like. The data portal 135 may be configured to access the LFA database 150.

Block 510 may include accessing the records in the record database 140. For example, the data portal 135 may be configured query the record server 110 for records that are related to in the LFA agreement (e.g., identified by the LFA information). Once identified, the data portal 135 may be configured to download the records. The downloaded records may be stored on the client machine 105 where they can be manipulated, revised, and saved locally to the client machine 105 until the user decides to upload the changes to the records to the record server 110. This client-based storage allows users to access and manipulate the record data without connectivity to the network 102 or to the record server 110.

Block 515 may include comparing the identified records from the record database 140 to the LFA information in the LFA database 150. For example, the data portal 135 may compare the identified records to the LFA information to determine whether the service provider is complying with the LFA agreement. In one exemplary implementation, the LFA agreement may specify that the service provider is to provide service to a minimum number of residences in a geographic area. The data portal 135 may determine whether the minimum number of residences in the geographic area are receiving services. If so, the data portal 135 may conclude that the service provider is complying with the LFA agreement. If not, the data portal 135 may conclude that the service provider is in violation of the LFA agreement. In one exemplary approach, compliance with the LFA agreement may be reported by a summary of all the records in the record server 110 and their statuses. The statuses may include one or more in-progress codes, completed codes, or exclusion codes from the LFA agreement. The summary reporting may indicate groupings of records and the associated counts and percentages of completions. For instance, the summary reporting may include a score of 90% that would indicate that the build out requirement of the LFA agreement is met for 90% of the target address records.

Block 520 may include issuing a notification to the user. For example, if the service provider is in compliance with the LFA agreement, the notification may be a report stating that additional provisioning is not necessary. However, if the service provider is not in compliance, the notification may indicate that additional provisioning is needed. The notification may be presented to the user in various ways. For example, the notification may be in the form of an electronic communication to the user (e.g., an email). Alternatively, the notification may be a message presented on the display device 120. The reporting and related compliance monitoring may include a commitment date that may be defined by the LFA agreement. This commitment date may define the target completion date for build-out completion for all target address records. Accordingly, there is no “non-compliance” unless the commitment date has passed and there are addresses without region review code exclusions or a completion status (i.e., the status score is less than 100%, indicating that some of the addresses are not completed or excluded, and still require more work).

In response to receiving the notification identified in block 520, the user may edit one or more records using the data portal 135, and upload the edited records to the server. If new provisioning is needed, the user may generate an order requesting new provisioning. In one exemplary approach, the data portal 135 may determine that new provisioning is needed and automatically generate the order. With the new order, the user may edit the records. For example, the user may wait until the order is processed to edit the record, or the data portal 135 may automatically update the record with the information in the order.

The process 500 may return to block 515 to compare the edited records to the LFA information to determine whether the service provider complies with the terms of the LFA agreement. If so, the process 500 may end. If not, the process 500 continues with block 520.

In one exemplary approach, the data portal 135 described in FIGS. 1-5 may allow a service provider's regional engineers to update engineering records associated with local franchise authority (LFA) agreements. The LFA agreements may define the service provider's obligation to provide service to customers within a specific area, such as a geographical area. For example, the LFA agreement may define a minimum percentage of residential and commercial buildings to which the service provider must provide service in a specific county. The data portal 135 may be used to determine whether the service provider has fulfilled its obligations under the LFA agreement, and if not, the data portal 135 may be used to determine the additional resources that must be provided to fulfill the LFA agreement.

The regional engineer may use the data portal 135 to identify records related to one or more LFA agreements and download the records from the record server 110 to the client machine 105. The regional engineer may review the records to determine which addresses (residential or commercial) are governed by the LFA agreement by, for example, comparing the addresses from the records to an outside source, such as US Postal Service records. Once the addresses are identified, the regional engineer may use the data portal 135 to determine, among other things, how many of the addresses are serviced by the service provider, which addresses are ready for service (e.g., are properly provisioned but are awaiting service), those addresses that need provisioning to receive service, and which addresses are excluded from the LFA agreement. This is one way the data portal 135 may be used as a deployment and compliance management tool. Such a compliance management tool may be helpful to regional engineers when deploying technology, such as fiber-to-the-premises technology.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising:
a first database configured to store agreement information corresponding to terms of an agreement between a service provider and a third party;
a second database configured to store records related to the agreement;
a computing device configured to compare the records to the agreement information to determine whether the service provider is in compliance with the terms of the agreement.

2. A system as set forth in claim 1, wherein the agreement includes a local franchising authority agreement indicating a minimum number of addresses to be serviced by the service provider.

3. A system as set forth in claim 2, wherein said computing device is configured to issue a notification if the service provider is at least one of in compliance with the terms of the agreement and in violation of the terms of the agreement.

4. A system as set forth in claim 2, wherein said records stored in said second database are related to fiber-to-the-premises service and wherein said computing device is used to determine whether fiber-to-the-premises service was deployed in accordance with the agreement.

5. A system as set forth in claim 1, wherein said computing device is configured to query the second database for records related to the agreement.

6. A system as set forth in claim 5, wherein said computing device is configured to present the records related to the agreement to a user.

7. A system as set forth in claim 6, wherein said computing device is configured to receive edits to one or more of the records from the user and upload one or more of the edited records to the second database.

8. A system as set forth in claim 7, wherein said computing device is configured to compare the edited records to the agreement information to determine whether the service provider is in compliance with the terms of the agreement.

9. A system as set forth in claim 1, wherein said computing device is configured to generate an order requesting provisioning if the service provider is in violation of the terms of the agreement.

10. A method comprising:
placing agreement information in a first database, the agreement information corresponding to terms of an agreement between a service provider and a third party;
storing records related to the agreement in a second database;
comparing the records to the agreement information with a computing device to determine whether the service provider is in compliance with the terms of the agreement.

11. A method as set forth in claim 10, wherein the agreement includes a local franchising authority agreement indicating a type of addresses to be serviced by the service provider.

12. A method as set forth in claim 11, further comprising issuing a notification if the service provider is at least one of in compliance with the terms of the agreement and in violation of the terms of the agreement.

13. A method as set forth in claim 10, further comprising querying the second database for records related to the agreement.

14. A method as set forth in claim 13, further comprising presenting the records related to the agreement to a user.

15. A method as set forth in claim 13, further comprising receiving edits to one or more of the records from the user and uploading one or more of the edited records to the second database.

16. A method as set forth in claim 15, further comprising comparing the edited records to the agreement information with a computing device to determine whether the service provider is in compliance with the terms of the agreement.

17. A method as set forth in claim 13, further comprising generating an order requesting provisioning if the service provider is in violation of the terms of the agreement.

18. A method as set forth in claim 10, wherein the records stored in the second database are related to fiber-to-the-premises service and wherein comparing the records to the agreement information includes determining whether fiber-to-the-premises service was deployed in accordance with the agreement.

19. A method comprising:
receiving a query from a user at a client machine;
downloading one or more of a plurality of records from a record server to the client machine based on the query;
presenting one or more of the downloaded records to the user;
receiving edits to the one or more of the downloaded records from the user; and
uploading one or more of the edited records to the record server.

20. A method as set forth in claim 19, wherein uploading one or more of the downloaded records to the record server includes replacing one or more of the plurality of records on the record server with one or more of the edited records.

21. A method as set forth in claim 20, further comprising running the query on the record server.

22. A method as set forth in claim 19, further comprising exporting one or more of the downloaded records.

23. A method as set forth in claim 19, wherein downloading one or more of a plurality of records includes downloading a copy of one or more of the plurality of records from the record server and leaving one or more of the plurality of records on the record server.

24. A method as set forth in claim 19, further comprising filtering the downloaded records.

25. A method as set forth in claim 19, wherein the records are related to fiber-to-the-premises service and further comprising comparing the records to agreement information.

26. A method as set forth in claim 25, wherein comparing the records to the agreement information includes determining whether fiber-to-the-premises service was deployed in accordance with the agreement.
